(19) United States
(12) Patent Application Publication
(10) Pub. No.: US 2019/0024682 A1
(43) Pub. Date: Jan. 24, 2019

(54) PISTON ASSEMBLY

(71) Applicant: Claverham Limited, Bristol (GB)

(72) Inventors: Andrew WALTON, Stafford (GB); Andrew WHITING, Bristol (GB)

(21) Appl. No.: 16/029,721

(22) Filed: Jul. 9, 2018

(30) Foreign Application Priority Data
Jul. 21, 2017 (EP) 17182633.2

(51) Int. Cl. F15B 19/00; F04B 53/14

(52) U.S. Cl. CPC F15B 19/005; F04B 53/144

(57) ABSTRACT

A piston assembly is disclosed comprising: a piston head; a piston rod; a sleeve surrounding the piston rod; a first seal arranged radially between the piston rod and sleeve; a channel extending through the sleeve or piston rod to an opening on an interior surface of the sleeve or an exterior surface of the piston rod, respectively, for allowing hydraulic fluid to pass into the opening and along the channel, wherein the opening is located on an opposite side of the first seal to the piston head; a sensor system arranged and configured to sense a property of the hydraulic fluid that has passed through the opening into the channel; and a monitoring system configured to determine a change in a value of said property of the hydraulic fluid.

### FOREIGN PRIORITY

This application claims priority to European Patent Application No. 17182633.2 filed Jul. 21, 2017, the entire contents of which is incorporated herein by reference.

### FIELD

The present disclosure relates generally to a piston assembly that is configured such that the leakage of hydraulic fluid to an exterior surface thereof is reduced or eliminated.

### BACKGROUND

Hydraulic piston assemblies may leak hydraulic fluid if one or more seal between the piston rod and the surrounding piston gland becomes worn or damaged, or if the external surface of the piston rod that moves past such seals becomes damaged. Some hydraulic piston assemblies are deliberately configured to leak some hydraulic fluid past these seals, in order to lubricate the seals and prevent seal degradation that may otherwise be caused by the piston rod moving across dry seals.

However, the leakage of hydraulic fluid past such seals and to the exterior of the piston is unsightly and may even be hazardous, and so it is desired to minimise or prevent such leakage. As such, piston assemblies that begin to leak significantly are generally required to be repaired, e.g. by replacing the seals. Such external leakage is one of the most common failures in hydraulic actuator systems and requires the unscheduled removal and repair of the hydraulic piston assemblies.

### SUMMARY

From a first aspect, the present disclosure provides a piston assembly comprising: a piston head for being driven by, or for driving, a hydraulic fluid; a piston rod connected to the piston head; a sleeve surrounding the piston rod; a first seal arranged radially between the piston rod and sleeve; a channel extending through the sleeve or piston rod, the channel having an opening and being in fluidic communication, via the opening, with an annular space defined between an interior surface of the sleeve and an exterior surface of the piston rod, wherein the opening is located on an opposite side of the first seal to the piston head; a sensor system arranged and configured to sense a property of the hydraulic fluid that has passed through the opening into the channel; and a monitoring system configured to determine a change in a value of said property of the hydraulic fluid.

As the monitoring system is configured to determine changes in said property of the hydraulic fluid, embodiments of the present disclosure are able to perform diagnostics of the piston assembly or hydraulic fluid.

The opening of the channel may be on the interior surface of the sleeve in embodiments wherein the channel extends through the sleeve, or may be in the exterior surface of the piston rod in embodiments wherein the channel extends through the rod.

The piston assembly comprises a piston cylinder in which the piston rod and piston head move. The sleeve around the piston rod may be the piston cylinder itself, or an insert between the piston cylinder and the piston rod.

The assembly may comprise a piston chamber in which the piston head is slidably mounted; wherein the assembly is configured to urge the hydraulic fluid into the piston chamber so as to drive movement of the piston head and the piston rod connected thereto, or wherein the assembly is configured such that movement of the piston rod and piston head drives hydraulic fluid out of or into the piston chamber.

For example, an external load may act on the piston rod, causing the piston rod and head to move and urge hydraulic fluid out of the piston chamber, thereby absorbing the force exerted by the load.

The piston rod has a longitudinal axis and said opening in said interior or exterior surface is axially located on the opposite side of the first seal to the piston head. Hydraulic fluid that leaks from the piston chamber and past the first seal then enters the opening of the channel.

The opening may be at a first end of the channel and the channel may extend to an opening at another end of the channel. The opening at the other end of the channel may be outside of the junction between the piston rod and surrounding sleeve. The opening at the other end of the channel may supply the hydraulic fluid from the channel to a container for the hydraulic fluid, such as to a reservoir of hydraulic fluid to be pumped into the piston chamber, or to a waste container.

The first seal may be arranged on the sleeve and the piston rod may be slidably mounted within the sleeve such that the piston rod is movable along the first seal; or the first seal may be arranged on the piston rod and the piston rod may be slidably mounted within the sleeve such that the first seal is movable along the sleeve.

The assembly may further comprise a second seal arranged radially between the piston rod and sleeve, wherein the opening into the channel is arranged between the first and second seals.

The sensor system may be configured to continuously or repeatedly sense said property.

The sensor system may comprise a sensor arranged in the channel for sensing said property of the hydraulic fluid whilst the hydraulic fluid is passing through the channel; and/or the channel may extend from said opening to a container for the hydraulic fluid, and the sensor system may comprise a sensor arranged and configured to sense the property of the hydraulic fluid whilst in the container.

Said property of the hydraulic fluid may be the flow rate of the hydraulic fluid through the channel or into the container, or the volume of the hydraulic fluid in the channel or the container.

The sensor system may comprise an optical and/or electronic sensor for sensing an optical and/or electrical characteristic of the hydraulic fluid, and a processor for determining a value of said property of the hydraulic fluid from the optical and/or electrical characteristic.

Said property of the hydraulic fluid may be opacity or colour of the hydraulic fluid.

The value of the property detected by the sensor may indicate the level of contamination or other degradation of the hydraulic fluid.

The optical characteristic used to determine said property of the hydraulic fluid may be the intensity or frequency of light transmitted by the hydraulic fluid or the level of refraction or reflection of light by the hydraulic fluid.

Alternative, or additional, types of sensor to those described above are contemplated for use in determining the value of the property of the hydraulic fluid. For example, an ultrasonic sensor may use ultrasonic waves to sense a characteristic of the fluid and the processor may use this information to determine the value of said property. Alternatively, the sensor may determine the weight of the fluid that has passed through the opening into the channel, e.g. for use in determining the volume of flow rate of the fluid having passed into the channel.

The monitoring system may be configured to determine if a value of said property increases above, or decreases below, a threshold value; and/or the monitoring system may be configured to determine if a rate of change of said property increases above, or decreases below, a threshold rate.

The monitoring system may include a data set in which a plurality of values for said property are correlated to a corresponding plurality of predicted remaining operating life time values for the piston assembly, and the monitoring system may be configured to compare a value of the property sensed by the sensing system with the data set and obtain an estimate of the remaining operating life time of the piston assembly therefrom; and/or the monitoring system may include a data set in which a plurality of rates of change in said property are correlated to a corresponding plurality of predicted remaining operating life time values for the piston assembly, and wherein the monitoring system is configured to compare a rate of change of the property sensed by the sensing system with the data set and obtain an estimate of the remaining operating life time of the piston assembly therefrom.

The remaining operating life time may be the duration of time that the piston assembly is predicted to be capable of operating before the value of said property of the hydraulic fluid is considered unacceptable, e.g. the operating time before the flow rate of hydraulic fluid through the channel becomes unacceptably high (which may be indicative of a failed seal) or before the opacity of the hydraulic fluid becomes unacceptably high (which may be indicative of excessive contamination of the hydraulic fluid). The data set may be obtained from previous trials.

The monitoring system may be configured to store said remaining operating life time, and/or display and/or send a signal to a computer indicative of said remaining operating life time.

The signal may indicate that the first seal should be replaced and/or that the hydraulic fluid should be cleaned or replaced.

The signal may indicate a date by which maintenance of the piston assembly should be completed.

Although the first seal has been described as being between the piston rod and the surrounding sleeve, it is contemplated that the first seal may alternatively be arranged between the piston head and a sleeve surrounding the piston head. The sleeve surrounding the piston head may be the piston cylinder, or an insert sleeve radially between the piston head and the piston cylinder.

Accordingly, from a second aspect the present disclosure provides a piston assembly comprising: a piston head for being driven by, or for driving, a hydraulic fluid; a first sleeve surrounding the piston head; a piston rod connected to the piston head; a second sleeve surrounding the piston rod; a first seal arranged radially between the piston head and first sleeve; a channel extending through one of the first sleeve, piston head, second sleeve or piston rod, wherein the channel extends to an opening in an interior surface of the first sleeve, an exterior surface of the piston head, an interior surface of the second sleeve, or an exterior surface of the piston rod, respectively, for allowing hydraulic fluid that has leaked across the first seal to pass through the opening and along the channel; a sensor system arranged and configured to sense a property of the hydraulic fluid that has passed through the opening into the channel; and a monitoring system configured to determine a change in a value of said property of the hydraulic fluid.

The first and second sleeve may be parts of the same sleeve, e.g. the piston cylinder. Alternatively, the first and second sleeves may be different sleeves, e.g. the first sleeve may be the piston cylinder and the second sleeve may be an adaptor sleeve arranged between the piston rod and piston cylinder.

The piston assembly of the second aspect may have any of the features described in relation to the first aspect, except that the first seal is located between the piston head and surrounding cylinder, rather than between the piston rod and surrounding cylinder.

The assembly comprises a piston chamber in which the piston head is slidably mounted. The assembly may be configured to urge the hydraulic fluid into a region of the piston chamber on a first side of the first seal so as to drive movement of the piston head and the piston rod connected thereto, or the assembly may be configured such that movement of the piston rod and piston head drives hydraulic fluid out of a region of the piston chamber on a first side of the first seal. The opening may be located on the opposite side of the first seal to said region of the piston chamber.

The piston rod has a longitudinal axis and said opening in said interior or exterior surface is axially located on the opposite side of the first seal to the region of the piston chamber. Hydraulic fluid that leaks from the piston chamber and past the first seal then enters the opening of the channel.

The first seal may be arranged on the piston head and the piston head may be slidably mounted within the first sleeve such that the first seal is movable along the first sleeve; or the first seal may be arranged on the first sleeve and the piston head may be slidably mounted within the first sleeve such that the piston head is movable along the first seal.

The assembly may further comprise a second seal arranged radially between the piston head and first sleeve, wherein the opening into the channel is arranged between the first and second seals; or may further comprise a second seal arranged radially between the piston rod and second sleeve, wherein the opening into the channel is arranged between the first and second seals.

From a third aspect the present disclosure provides a piston assembly comprising: a piston head for being driven by, or for driving, a hydraulic fluid; a piston rod connected to the piston head; a sleeve surrounding the piston rod; a first seal arranged radially between the piston rod and sleeve; a channel extending through the sleeve or piston rod to an opening in an interior surface of the sleeve or an exterior surface of the piston rod, respectively, for allowing hydraulic fluid to pass through the opening and along the channel, wherein the opening is located on an opposite side of the first seal to the piston head; a sensor system arranged and configured to sense a flow rate or optical characteristic of the hydraulic fluid that has passed through the opening and into the channel; and a monitoring system for determining a change in said flow rate or optical characteristic.

The piston assembly of the third aspect may have any of the features described in relation to the first aspect of the present disclosure.

Embodiments of the present disclosure also relate to an actuator comprising a piston assembly as described herein and a load coupled to the piston rod or piston head such that movement of the piston head drives a movement of the load.

Embodiments of the present disclosure also relate to a flight control system for an aircraft comprising the piston assembly or actuator described herein.

### BRIEF DESCRIPTION OF THE DRAWINGS

Various embodiments will now be described, by way of example only, and with reference to the accompanying drawings in which:

FIG. 1 shows a schematic of part of a known piston assembly; and

FIG. 2 shows a schematic of part of a piston assembly according to an embodiment of the present disclosure.

### DETAILED DESCRIPTION

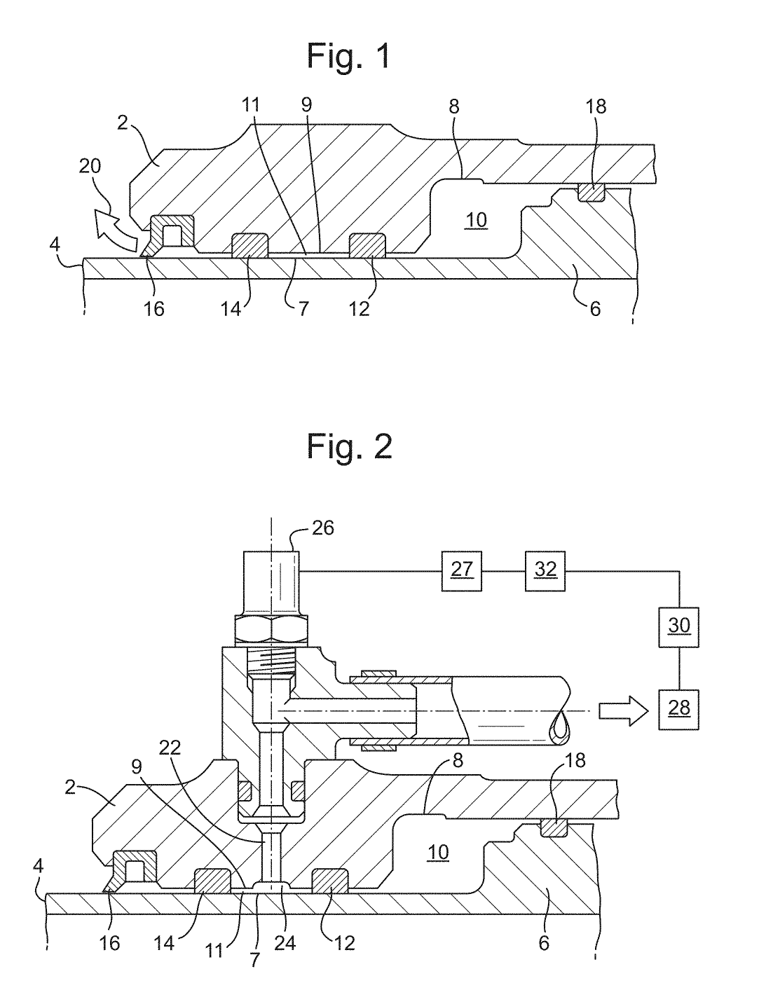

FIG. 1 shows a schematic of a portion of a hydraulic piston assembly of a known hydraulic actuator. The piston assembly comprises a piston cylinder 2 having a bore therein, and an elongated piston rod 4 connected to a piston head 6 mounted within the bore such that the piston rod 4 and piston head 6 may move relative to the cylinder 2 in directions along the longitudinal axis of the piston rod 4. The interior surface 7 of the cylinder 2 and the exterior surface 9 of the piston rod 4 define an annular space 11 therebetween. The bore of the cylinder 2 has a relatively small diameter along a first length, in which the piston rod 4 is held in place radially, and has a relatively large diameter over a second length, forming a chamber 8 in which the piston head 6 is held radially. As is known in the art, the piston head 6 may be moved in a first axial direction by supplying pressurised hydraulic fluid 10 to the chamber 8 on a first side of the piston head 6. The piston head 6 may be allowed to move in a second, opposite axial direction by allowing the hydraulic fluid 10 on the first side of the piston head 6 to leave the chamber 8 and may be driven in this direction (i.e. in a double acting cylinder) or by supplying pressurised hydraulic fluid to the chamber 8 on a second, opposite side of the piston head 6 (not shown). The piston rod 4 moves with the piston head 6 and a load is generally coupled to the piston rod 4 such that movement of the piston head 6 moves the load. The piston assembly thereby forms an actuator for moving the load.

Various seals 12-18 are provided radially between the cylinder 2 and the piston rod 4, and between the cylinder 2 and piston head 6, in order to inhibit the flow of the hydraulic fluid 10 away from the piston head chamber 8, between the cylinder 2 and the piston rod 4 and to an external surface of the piston assembly. In the arrangement shown, a seal 18 is provided on the circumferential surface of the piston head 6, so as to make sealing contact with the surrounding chamber 8 as the piston head 6 moves relative thereto. A primary seal 12 and a secondary seal 14 are also provided circumferentially around the internal surface of the cylinder 2, so as to make sealing contact with the piston rod 4 as the piston rod 4 moves relative to the cylinder 2.

A scraper seal 16 is also provided between the cylinder 2 and the piston rod 4, towards the end of the piston rod 4 that is distal from the piston head 6. The scraper seal 16 is provided circumferentially around the internal surface of the cylinder 2, so as to make sealing contact with the piston rod 4 as the piston rod 4 moves relative to the cylinder 2. The scraper seal 16 is configured to scrape contaminants, such as dust and other debris, off the piston rod 4 as the piston rod 4 moves towards the chamber 8 (to the right in FIG. 1), such that the movement does not cause external contaminants to be drawn between the piston rod 4 and cylinder 2 and into contact with the primary and secondary seals 12,14, which may cause damage to those seals or interfere with their sealing ability.

As described above, in use, pressurised hydraulic fluid 10 is supplied to the chamber 8 so as to drive the piston head 6 in one direction or the other. Some of this hydraulic fluid 10 leaks past the seals 12-14, partly due to the fluid 10 being pressurised, but also because the movement of the piston rod 4 draws the hydraulic fluid 10 past the seals 12-14. For example, when the piston rod 4 moves away from the chamber 8 (to the left in FIG. 1), hydraulic fluid 10 on the external surface of the piston rod 4 will be drawn past the primary seal 12, past the secondary seal 14, and eventually past the scraper seal 16 such that the hydraulic fluid 10 leaks to an exterior surface of the piston assembly, as indicated by arrow 20. The amount of leakage of the hydraulic fluid 10 increases as the various seals 12-16 degrade or become damaged.

FIG. 2 shows a schematic of a portion of a hydraulic piston assembly according to an embodiment of the present disclosure. The piston assembly may form part of an actuator. The piston assembly comprises the same components as described in relation to FIG. 1, which are designated with the same reference numbers. Accordingly, the piston assembly comprises a piston cylinder sleeve 2 having a bore therein, and an elongated piston rod 4 connected to a piston head 6 mounted within the bore such that the piston rod 4 and piston head 6 may move relative to the cylinder 2 in directions along the longitudinal axis of the piston rod 4. The bore of the cylinder 2 has a relatively small diameter along a first length, in which the piston rod 4 is held in place radially, and has a relatively large diameter over a second length, forming a chamber 8 in which the piston head 6 is held radially. As is known in the art, the piston head 6 may be moved in a first axial direction by supplying pressurised hydraulic fluid 10 to the chamber 8 on a first side of the piston head 6. The piston head 6 may be allowed to move in a second, opposite axial direction by allowing the hydraulic fluid 10 on the first side of the piston head 6 to leave the chamber 8 and may be driven in this direction (e.g. in a duplex actuator) or by supplying pressurised hydraulic fluid to the chamber 8 on a second, opposite side of the piston head 6 (not shown). The piston rod 4 moves with the piston head 6 and a load may be coupled to the piston rod 4 or piston head 6 such that movement of the piston rod 4 and head 6 moves the load. The piston assembly may therefore form part of an actuator for controllably moving the load. For example, the piston assembly may be part of a hydraulically actuated machine such or a hydraulic control system.

Various seals 12-18 are provided radially between the cylinder 2 and the piston rod 4, and between the cylinder 2 and piston head 6, in order to prevent or inhibit the flow of the hydraulic fluid 10 away from the piston head chamber 8, between the cylinder 2 and the piston head 6 or rod 4 and to an external surface of the piston assembly. In the arrangement shown, a seal 18 is provided on the circumferential surface of the piston head 6, so as to make sealing contact with the surrounding chamber 8 as the piston head 6 moves relative thereto. A primary seal 12 and a secondary seal 14 are also provided circumferentially around the internal surface of the cylinder 2, so as to make sealing contact with the piston rod 4 as the piston rod 4 moves relative to the cylinder 2. The various seals may be 0-rings, or other types of seals as are known in the art.

A scraper seal 16 is also provided between the cylinder 2 and the piston rod 4 towards the end of the piston rod 4 that is distal from the piston head 6. The scraper seal 16 is provided circumferentially around the internal surface of the cylinder 2, so as to make sealing contact with the piston rod 4 as the piston rod 4 moves relative to the cylinder 2. The scraper seal 16 is configured to scrape contaminants, such as dust and other debris, off the piston rod 4 as the piston rod 4 moves towards the chamber 8 (to the right in FIG. 2), such that the movement does not cause external contaminants to be drawn between the piston rod 4 and cylinder 2 and into contact with the primary and secondary seals 12-14, which may cause damage to those seals or interfere with their sealing ability.

The cylinder 2 comprises a radial channel 22 having an opening 24 on the interior surface of the cylinder 2 at an axial location between the primary and secondary seals 12-14. The channel 22 is therefore in fluidic communication with an annular space 11 defined by the interior surface 9 of the cylinder 2 and an exterior surface 7 of the piston rod 4.

The opening 24 and channel 22 are arranged and configured to remove hydraulic fluid 10 that has passed between the piston rod 4 and cylinder 2 and into the region between the primary and second seals 12-14. The channel 22 may lead to a storage or waste container 28, or may form part of a return line that recycles the hydraulic fluid 10 back into a reservoir for supplying hydraulic fluid to the piston chamber 8. A sensor system having a sensor 26 and processor 27 may also be provided for sensing a property of the hydraulic fluid 10 flowing through the channel 24.

As described above, in use, pressurised hydraulic fluid 10 is supplied to the chamber 8 so as to drive the piston head 6 in one direction or the other. Some of this hydraulic fluid 10 leaks past the primary seal 12 to the axial region between the primary and secondary seals 12-14, partly due to the fluid 10 being pressurised, but also because the movement of the piston rod 4 draws the hydraulic fluid 10 past the primary seal 12. For example, when the hydraulic fluid 10 is supplied to the chamber 8 such that it moves the piston rod 4 away from the chamber 8 (to the left in FIG. 2), hydraulic fluid 10 on the external surface of the piston rod 4 will be drawn past the primary seal 12. The amount of leakage of the hydraulic fluid 10 past the primary seal 12 increases as the seal degrades or becomes damaged (or if the part of the piston rod 4 passing the seal 12 becomes damaged).

The hydraulic fluid 10 then passes into opening 24 and into the channel 22 and flows out of the region between the primary and secondary seals 12-14. This may be achieved, for example, by arranging the channel 22 such that the hydraulic fluid 10 flows into the channel 22 by the effect of gravity. Alternatively, the opening 24 into the channel 22 may be at a higher pressure than the opening at the other end of the channel 22 (not shown). Such a pressure difference may be maintained by a pump, for example. As such, the hydraulic fluid 10 is removed from the region between the seals 12-14 by the channel 22, it is less likely to be drawn past the secondary seal 14 by the movement of the piston rod 4 past the secondary seal 14. Leakage of hydraulic fluid 10 to the external surface of the piston assembly is therefore reduced or eliminated.

The sensor 26 may be configured to sense the rate that hydraulic fluid 10 passes through the channel 22 and/or the cumulative volume of hydraulic fluid 10 that has passed into the channel 22. For example, the sensor 26 may be an optical sensor having processing electronics configured to determine the fluid flow rate or volume from light detected by the sensor 26. However, other types of sensors for measuring the flow rate or volume are known and may be used in the embodiments described herein.

Alternatively, the hydraulic fluid 10 may flow from the channel 22 to a storage or waste container 28 and a sensor 30 may be located and configured to determine the volume of hydraulic fluid 10 in the container 26 (i.e. that has passed through the channel 22 to the container 26). The sensor 30 may be an optical sensor or other type of sensor that determines the volume of fluid that has passed into the container 28. For example, the sensor 30 may detect the position of the upper surface of the hydraulic fluid in the container 28 and determine the volume of fluid from this position (e.g. optically or using a mechanical float sensor).

The sensors 26,30 may be coupled to a monitoring system 32 for determining a change in the value of the property of the hydraulic fluid being sensed by the sensor 26. The monitoring system may monitor the rate at which the hydraulic fluid is passing into the channel 22, which is indicative of the rate at which hydraulic fluid is leaking past the primary seal 12 and therefore indicative of the condition of the seal 12 and/or the exterior surface of piston rod 4 passing seal 12. The monitoring system 32 may be calibrated so that it is able to determine an abnormal flow rate or volume of the hydraulic fluid. For example, if the system 32 determines that the flow rate or volume is above a predetermined value then the system 32 may determine that the seal 12 and/or piston rod 4 is not functioning normally. An algorithm may be used to make this comparison. If abnormal functioning is determined then the system 32 may activate an alarm.

The monitoring system 32 may be configured to estimate the remaining operating life time that the piston assembly is capable of functioning before any leakage, or an unacceptably high rate of leakage, of hydraulic fluid to an external surface of the piston assembly occurs. The system 32 may include data in which a plurality of flow rates or volumes are correlated to a corresponding plurality of remaining operating life time values. The system 32 may compare the flow rate or volume detected by the sensor 26,30 to the data to obtain an estimate of the remaining operating life time of the piston assembly. Alternatively, the system 32 may include data in which the rate of change in the flow rate is correlated to the remaining operating life time. The system 32 may compare the rate of change in the flow rate detected by the sensor 26,30 to this data to obtain an estimate of the remaining operating life time of the piston assembly. In these embodiments, the estimated remaining operating life time may be logged, displayed or sent to a computer. An alarm may be activated or an alarm signal may be sent when the estimated remaining operating life time falls below a predetermined threshold value.

In addition, or alternatively, to monitoring the flow rate or volume, one or more sensor 26,30 may be provided for monitoring the condition of the hydraulic fluid that has passed into the channel 22. The sensor may be provided in the channel 22 or downstream thereof, e.g. to analyse the fluid in a storage/waste container 28. The sensor 26,30 may be an optical sensor for measuring an optical property of the hydraulic fluid, such as the opacity or colour of the fluid, e.g. by detecting an optical characteristic such as the intensity of light transmitted by the hydraulic fluid. The value of the property detected by the sensor 26,30 may indicate the level of contamination or other degradation of the hydraulic fluid.

The sensor 26,30 may be coupled to a monitoring system 32 for monitoring the condition of the hydraulic fluid. The monitoring system 32 may be calibrated so that it is able to determine an abnormal condition of the hydraulic fluid. For example, if the system 32 determines that the level of light transmitted by the hydraulic fluid to the sensor 26,30 is lower than a predetermined value then the system 32 may determine that the hydraulic fluid is contaminated or degraded. An algorithm may be used to make this comparison. If such contamination or degradation is determined then the system 32 may activate an alarm.

The monitoring system 32 may be configured to estimate the remaining operating life time that the hydraulic fluid may be used. The system may include data in which a plurality of values of the detected property are correlated to a corresponding plurality of remaining operating life time values for the hydraulic fluid. The system 32 may compare the value detected by the sensor 26,30 to the data to obtain an estimate of the remaining operating life time of the hydraulic fluid. Alternatively, the system 32 may include data in which the rate of change in the value is correlated to the remaining operating life time. The system 32 may compare the rate of change in the value detected by the sensor 26,30 to this data to obtain an estimate of the remaining operating life time of the hydraulic fluid. In these embodiments, the estimated remaining operating life time may be logged, displayed or sent to a computer. An alarm may be activated or an alarm signal may be sent when the estimated remaining operating life time falls below a predetermined threshold value.

If the flow rate/volume and the condition of the hydraulic fluid are monitored, the same sensor may be used to monitor both (e.g. an optical sensor) or one sensor may be used to monitor the flow rate/volume and another sensor may be used to monitor the condition.

Although an optical sensor has been described for use in monitoring the condition of the hydraulic fluid, it is contemplated that other types of sensor may be employed. For example, sensors that determine the electrical properties (e.g. capacitance or resistance) of the hydraulic fluid may be used to determine its condition.

Embodiments of the present disclosure reduce or eliminate leakage of hydraulic fluid to the external surfaces of the piston assembly. This is particularly useful in aerospace hydraulic actuators, to which embodiments of the present disclosure relate. For example, embodiments relate to aircraft systems, such as primary flight controls, and other commercial hydraulic equipment.

As embodiments of the present disclosure reduce or eliminate leakage of hydraulic fluid to the external surfaces of the piston assembly, the mean time before overhaul of the piston assembly may be extended, increasing the availability of the assembly and reducing the life-cost associated therewith.

Embodiments of the present disclosure are able to determine the condition of one or more seals in the piston assembly and/or the remaining operational lifetime of the piston assembly before unacceptable leakage of hydraulic fluid occurs. Maintenance of the piston assembly may therefore be planned in advance (or “On Condition” maintenance), rather than unscheduled maintenance and unscheduled downtime having to occur.

Embodiments of the present disclosure enable analysis of in service data versus qualification endurance test data.

Although the present disclosure has been described with reference to various embodiments, it will be understood by those skilled in the art that various changes in form and detail may be made without departing from the scope of the invention as set forth in the accompanying claims.

For example, although the bore of the cylinder 2 has been described as having a relatively small diameter along a first length (in which the piston rod 4 is held in place radially) and a relatively large diameter over a second length (forming a chamber 8 in which the piston head 6 is held radially), it is contemplated that the cylinder 2 itself need not necessarily be configured to provide these differing diameter first and second lengths. Rather, an insert sleeve may be inserted between the cylinder 2 and piston rod 4 to form the chamber 6 and the seals 12-16 may be provided on the insert sleeve.

Although embodiments have been described in which the opening 24 to the channel 2 is located axially between the primary and secondary seals 12-14, it is contemplated that the opening 24 may be located “downstream” of any of the seals between the piston rod 4 and the surrounding cylinder/sleeve 2. However, the opening 24 is desirably axially located between two such seals. For example, the opening 24 may be axially located between the secondary seal 14 and the scraper seal 16, or the secondary seal 14 may be omitted and the opening 24 may be axially located between the primary seal 12 and the scraper seal 16. It is contemplated that the piston assembly may comprise multiple pairs of axially adjacent seals and at least one such opening 24 may be provided between the seals in each pair.

Embodiments are also contemplated wherein the piston assembly is a double acting cylinder and an opening to a channel is provided on each side of the piston chamber 8 such that leakage of hydraulic fluid is reduced or prevented on either side of the piston chamber.

Although embodiments have been described in which the opening 24 and channel 22 are in the cylinder/sleeve 2, it is contemplated that the opening 24 may be on an exterior surface of the piston rod 4 and the channel 22 may be provided in the piston rod 4.

1. A piston assembly comprising:
a piston head for being driven by, or for driving, a hydraulic fluid;
a piston rod connected to the piston head;
a sleeve surrounding the piston rod;
a first seal arranged radially between the piston rod and sleeve;
a channel extending through the sleeve or piston rod, the channel having an opening and being in fluidic communication, via the opening, with an annular space defined between an interior surface of the sleeve and an exterior surface of the piston rod, wherein the opening is located on an opposite side of the first seal to the piston head;
a sensor system arranged and configured to sense a property of the hydraulic fluid that has passed through the opening into the channel; and
a monitoring system configured to determine a change in a value of said property of the hydraulic fluid.

2. The assembly of claim 1, comprising a piston chamber in which the piston head is slidably mounted; wherein the assembly is configured to urge the hydraulic fluid into the piston chamber so as to drive movement of the piston head and the piston rod connected thereto, or wherein the assembly is configured such that movement of the piston rod and piston head drives hydraulic fluid out of or into the piston chamber.

3. The assembly of claim 1, wherein the first seal is arranged on the sleeve and the piston rod is slidably mounted within the sleeve such that the piston rod is movable along the first seal; or
wherein the first seal is arranged on the piston rod and the piston rod is slidably mounted within the sleeve such that the first seal is movable along the sleeve.

4. The assembly of claim 1, further comprising:
a second seal arranged radially between the piston rod and sleeve, wherein the opening into the channel is arranged between the first and second seals.

5. The assembly of claim 1, wherein the sensor system is configured to continuously or repeatedly sense said property.

6. The assembly of claim 1, wherein:
the sensor system comprises a sensor arranged in the channel for sensing said property of the hydraulic fluid whilst the hydraulic fluid is passing through the channel; or
the channel extends from said opening to a container for the hydraulic fluid, and wherein the sensor system comprises a sensor arranged and configured to sense the property of the hydraulic fluid whilst in the container.

7. The assembly of claim 6, wherein said property of the hydraulic fluid is the flow rate of the hydraulic fluid through the channel or into the container, or the volume of the hydraulic fluid in the channel or the container.

8. The assembly of claim 1, wherein the sensor system comprises an optical and/or electronic sensor for sensing an optical or electrical characteristic of the hydraulic fluid, and a processor for determining a value of said property of the hydraulic fluid from the optical or electrical characteristic.

9. The assembly of claim 8, wherein said property of the hydraulic fluid is opacity or colour of the hydraulic fluid.

10. The assembly of claim 1, wherein the monitoring system is configured to determine if a value of said property increases above, or decreases below, a threshold value; or
wherein the monitoring system is configured to determine if a rate of change of said property increases above, or decreases below, a threshold rate.

11. The assembly of claim 1, wherein the monitoring system includes a data set in which a plurality of values for said property are correlated to a corresponding plurality of predicted remaining operating life time values for the piston assembly, and wherein the monitoring system is configured to compare a value of the property sensed by the sensing system with the data set and obtain an estimate of the remaining operating life time of the piston assembly therefrom; or
wherein the monitoring system includes a data set in which a plurality of rates of change in said property are correlated to a corresponding plurality of predicted remaining operating life time values for the piston assembly, and wherein the monitoring system is configured to compare a rate of change of the property sensed by the sensing system with the data set and obtain an estimate of the remaining operating life time of the piston assembly therefrom.

12. The assembly of claim 11, wherein the monitoring system is configured to store said remaining operating life time, or display or send a signal to a computer indicative of said remaining operating life time.

13. A piston assembly comprising:
a piston head for being driven by, or for driving, a hydraulic fluid;
a first sleeve surrounding the piston head;
a piston rod connected to the piston head;
a second sleeve surrounding the piston rod;
a first seal arranged radially between the piston head and first sleeve;
a channel extending through one of the first sleeve, piston head, second sleeve or piston rod, wherein the channel extends to an opening in an interior surface of the first sleeve, an exterior surface of the piston head, an interior surface of the second sleeve, or an exterior surface of the piston rod, respectively, for allowing hydraulic fluid that has leaked across the first seal to pass through the opening and along the channel;
a sensor system arranged and configured to sense a property of the hydraulic fluid that has passed through the opening into the channel; and
a monitoring system configured to determine a change in a value of said property of the hydraulic fluid.

14. The assembly of claim 13, further comprising:
a second seal arranged radially between the piston head and the first sleeve, wherein the opening into the channel is arranged between the first and second seals; or
a second seal arranged radially between the piston rod and the second sleeve, wherein the opening into the channel is arranged between the first and second seals.

15. A piston assembly comprising:
a piston head for being driven by, or for driving, a hydraulic fluid;
a piston rod connected to the piston head;
a sleeve surrounding the piston rod;
a first seal arranged radially between the piston rod and sleeve;
a channel extending through the sleeve or piston rod to an opening in an interior surface of the sleeve or an exterior surface of the piston rod, respectively, for allowing hydraulic fluid to pass through the opening and along the channel, wherein the opening is located on an opposite side of the first seal to the piston head;
a sensor system arranged and configured to sense a flow rate or optical characteristic of the hydraulic fluid that has passed through the opening and into the channel; and
a monitoring system for determining a change in said flow rate or optical characteristic.
